(19) United States
(12) Patent Application Publication
(10) Pub. No.: US 2022/0194867 A1
(43) Pub. Date: Jun. 23, 2022

(54) PRIMER THICKNESS CONTROL ON POROUS CERAMIC BODIES

(71) Applicant: CORNING INCORPORATED, Corning, NY (US)

(72) Inventors: Mickaël Berrebi, Paris (FR); Kathy Margaret Corcoran, Corning, NY (US); Christopher Paul Daigler, Cedar Park, TX (US); David Henry, Fontaine le Port (FR); Brian Christopher Lewis, Painted Post, NY (US); Hideki Masaki, Corning, NY (US); Kevin Ray Maslin, Athens, PA (US)

(21) Appl. No.: 17/604,529

(22) PCT Filed: Apr. 13, 2020
(86) PCT No.: PCT/US2020/027888

§ 371 Date: Oct. 18, 2021

Related U.S. Application Data
(60) Provisional application No. 62/835,775, filed on Apr. 18, 2019.

(51) Int. Cl. C04B 41/45; C04B 41/00; C04B 41/46; C04B 41/82; B01D 46/24; B01D 46/00

(52) U.S. Cl. CPC C04B 41/4511; C04B 41/009; C04B 41/46; C04B 41/0036; B01D 2279/30; B01D 46/2474; B01D 46/2482; B01D 46/009; C04B 41/82

(57) ABSTRACT

A fired ceramic article including a screen printed layer of primer on a portion of the fired ceramic body. The thickness of the primer layer is less than 25 microns. A machine-readable code is laser marked onto the screen printed layer of primer. Methods of marking a ceramic article are also provided.

This application claims the benefit of priority under 35 U.S.C. § 119 of U.S. Provisional Application No. 62/835,775 filed on Apr. 18, 2019, the content of which is incorporated herein by reference in its entirety.

### FIELD

Embodiments described herein generally relate to methods for manufacturing porous ceramic bodies, and more particularly to methods of controlling primer thickness while applying a primer coating to porous ceramic bodies.

### BACKGROUND

Bar codes (e.g., having a sequence of variable black lines on a contrasting background), data matrix codes (e.g., having an array of inter-connected squares on a contrasting background) and other machine-readable codes are used in various industries to enable information (e.g., processing and product information) to be stored directly on and/or associated with a product or item, and retrievable via a corresponding scanner or device configured to read the code.

For example, the manufacturing of porous ceramic honeycomb bodies or articles, such as used as catalytic converter substrates or particulate filters includes the application of a data carrying mark comprising a machine-readable code to the ceramic body.

There is a need for cost-efficient and effective methods and systems for applying data carrying marks and machine-readable codes during the manufacture of porous ceramic honeycomb bodies.

### BRIEF SUMMARY OF THE INVENTION

Honeycomb bodies manufactured for the catalytic converter substrate and filter industry may benefit from data carrying marks (e.g., machine-readable codes) printed on each body that enable information pertaining to each body to be associated with each body. The present disclosure addresses the performance requirements of the materials used to create the necessary contrast between the background and foreground colors of the codes that enables the codes to be machine readable. In embodiments disclosed herein, a white primer layer is first applied to the outer skin of the honeycomb body and then the code is applied over the primer in a darker, contrasting color, such as via laser burning. Creation of the code according to the embodiment disclosed herein comprises applying the white background primer via screen printing. The use of screen printing to apply the primer layer to a porous ceramic honeycomb body advantageously enables high processing speeds including drying, code processing, and inspection while providing a code with good readability.

In one aspect, a fired ceramic body is provided. The fired ceramic body comprises a screen printed layer of primer on a portion of the fired ceramic body, wherein the thickness of the primer layer is less than 25 microns; and a machine-readable code laser marked onto the screen printed layer of primer.

In some embodiments, the fired ceramic article is porous and the primer layer penetrates the porous ceramic body to a depth of at least 10 microns. In some embodiments, before being dried, the primer layer comprises TiO2 pigment, binder, high boiling solvent, and thickener. In some embodiments, after being dried, the primer layer comprises TiO2 pigment. In some embodiments, the machine-readable code contains traceability information.

In some embodiments, the thickness of the white primer layer is substantially uniform. In some embodiments, the laser depth exceeds the thickness of the primer. In some embodiments, the thickness of the primer layer is greater than zero to less than or equal to about 22 microns. In some embodiments, the white primer layer is substantially free of flaking. In some embodiments, the white primer layer is substantially free of cracking. In some embodiments, a wall-flow filter is provided comprising a ceramic body disclosed herein.

In another aspect, a label is provided, comprising (a) a layer of primer wherein the primer layer was screen printed and the thickness of the primer layer is greater than zero to less than or equal to 25 microns; and (b) a machine-readable code laser marked onto the primer layer.

In another aspect, a method of marking a ceramic article is provided, comprising the steps of (a) screen printing a layer of primer at a thickness of greater than zero to less than 25 microns onto a portion of a fired ceramic article; (b) drying the primer layer; and (c) laser marking a machine-readable code on the dried primer layer.

In some embodiments, the fired ceramic article is porous and the primer layer penetrates the porous fired ceramic article for at least 10 microns. In some embodiments, in the step (a), the primer layer comprises TiO2 pigment, binder, high boiling solvent, and thickener. In some embodiments, in the step (a) the thickness of the primer layer is greater than zero to less than or equal to about 22 microns. In some embodiments, the thickness of the primer layer is substantially uniform. In some embodiments, the primer layer is substantially free of cracking. In some embodiments, the machine-readable code contains traceability information. In some embodiments, in the step (c), the machine-readable code is marked to the porous fired ceramic article.

### BRIEF DESCRIPTION OF THE DRAWINGS/FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows the thickness of the primer and subsurface penetration for each substrate (ceramic article) in the Examples.

FIG. 2 shows SEMs for the Examples of FIG. 1.

FIG. 3 shows the results of an aluminum cup test for the Examples.

FIGS. 4A-4C shows SEMs for Substrates 1, 2, and 3 with primer layers screen printed using a 380/31 mesh.

FIGS. 5A-5F shows a side by side SEM comparison after screen printing with 180 mesh screen and a 380 mesh screen on Substrate 3.

FIG. 6 shows the binder penetration into the code.

FIGS. 7A-7C shows the impact of thickness on cracking of the primer layer.

FIG. 8 shows an SEM of a screen printed primer on Substrate 1 for Comparative D.

FIG. 9 shows a box and whisker plot for the primer thickness on Substrate 3 using 305/34, 380/31, and 420/27 mesh for Example 6.

### DETAILED DESCRIPTION OF THE INVENTION

The present invention(s) will now be described in detail with reference to embodiments thereof as illustrated in the accompanying drawings. References to “one embodiment,” “an embodiment,” “an exemplary embodiment,” “some embodiments”, etc., indicate that the embodiment(s) described may include a particular feature, structure, or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Definitions: “Thickness” as used herein with respect to the application of primer on the skin of a ceramic body refers to the distance that the primer is present above the outer surface of the skin of the body. With respect to a cylindrical body, the thickness refers to the radial dimension of the primer layer measured outwardly from the outer surface of the body.

“Depth” as used herein with respect to a dimension of the primer layer refers to the distance that the primer has penetrated into the skin (and/or walls) of the ceramic body. With respect to a cylindrical body, the depth that the primer penetrates into the substrate refers to the radial distance that the primer penetrates into the skin and/or walls of body.

“Laser Depth” as used herein refers to the distance that the laser is able to penetrate the primer thickness and fuse the primer to the skin of the ceramic body.

Examples of ceramic batch material mixtures for forming cordierite that can be used in practicing the current embodiments are disclosed in commonly assigned U.S. Pat. Nos. 3,885,977; 4,950,628; 5,183,608; 5,258,150; 6,210,626; 6,368,992; 6,432,856; 6,506,336; 6,773,657; 6,864,198; 7,141,089; and 7,179,316, all incorporated herein by reference in their entireties. Cordierite bodies are formed from inorganic materials including high-purity clay, silica, alumina, and magnesia that can be supplied in the form of talc, kaolin, aluminum oxide, and amorphous silica powders, and may contain other materials as indicated in the cited art. The powders are combined in proportions such as recited in the art as being suitable for forming cordierite bodies. In addition to cordierite, other porous ceramic materials, such as aluminum titanate, can be used.

A batch of ceramic precursor can be dry mixed with a temporary binder such as methylcellulose material to form a dry batch. The ingredients can be compounded by being mixed, for example, in a muller or plow blade mixer. A suitable liquid vehicle, such as water, together with a plasticizer or lubricant can be added and mulled to form a plasticized batch. With water as the solvent, the water hydrates the binder and the powder particles. The surfactant and/or lubricant, if desired, can then be added to the mix to wet out the binder and powder particles. The plasticized batch is then formed, such as by extrusion through a die, into a honeycomb green body as described in commonly assigned U.S. Pat. No. 5,205,991, incorporated herein by reference in its entirety.

The plasticized batch can comprise any number of peptizing agents, binding agents such as methyl cellulose, extrusion aids, lubricants such as sodium stearate, plasticizers, reinforcement agents, and the like to assist in the extrusion process and/or generate the desired structural and pore properties for an intended application. Examples of materials that may be included in an extrusion formula include, but are not limited to glass or ceramic fibers or strands, silicon carbide fibers, cellulose compounds, starches, stearic alcohols, graphite, stearic acid, oils, fats, and polymers.

The precursor batch may then be plasticized by shearing the wet mix formed above in any suitable mixer in which the batch will be plasticized, such as, but not limited to, a twin-screw extruder/mixer, auger mixer, muller mixer, Littleford mixer, or double arm etc. The plasticized batch may also be formed, such as by extrusion through a die, to form a green body honeycomb as described in commonly assigned U.S. Pat. No. 5,205,991, incorporated herein by reference in its entirety. Extent of plasticization is dependent on the concentration of the components (binder, solvent, surfactant, oil lubricant, and the inorganics), temperature of the components, the amount of work put into the batch, the shear rate, and extrusion velocity. During plasticization, the binder dissolves in the solvent and a high viscosity fluid phase is formed. The binder formed is stiff because the system is very solvent-deficient. The surfactant enables the binder phase to adhere to the powder particles.

When the green honeycomb article is formed by extrusion, the extrusion may be performed using a hydraulic ram extrusion press, or alternatively, a two stage de-airing single auger extruder, or a twin screw mixer with a die assembly attached to the discharge end. This wet green ware body is then dried to form a dry green body. Useful drying techniques include microwave drying, RF drying, infrared heating, forced hot air drying, ambient air drying, and the like and combinations thereof. The drying may be in humidity and temperature controlled environments. The green ware is then fired in a suitable furnace to form a ceramic honeycomb article.

The presently described labeled ceramic honeycomb body may be used as anti-pollutant devices, e.g., in the exhaust systems of automotive vehicles, such as catalytic converter substrates or particulate filters, e.g., in gasoline or diesel-powered vehicles. Ceramic honeycomb articles for use in such applications are formed from a matrix of thin, porous ceramic walls that define a plurality of parallel, gas conducting channels. In ceramic honeycomb articles used as catalytic substrates in automobiles with gasoline engines, the gas conducting channels can be open at both ends. A catalytic coating is applied to the outer surfaces of the walls. Exhaust gases flowing through the channels come into contact with catalytic coatings on the surfaces of the walls. These honeycomb articles are referred to as flow-through substrates.

Filters comprise a honeycomb design having an inlet end and an outlet end and a multiplicity of cells extending from the inlet end to the outlet end, the cells having porous walls, wherein some of the total number of cells at the inlet end are plugged along a portion of their lengths, and the remaining cells are open at the inlet end are plugged at the outlet end along a portion of their lengths, so that an engine exhaust stream passing through the cells of the honeycomb from the inlet end to the outlet end flows into the open cells, through the cell walls, and out of the structure through the open cells at the outlet end.

Generally, honeycomb cell densities range from 235 cells/cm² (about 1500 cells/in²) to 1 cell/cm² (about 6 cells/in²). Some examples of commonly used honeycombs in addition to these, include but are not limited to, about 94 cells/cm² (about 600 cells/in²), about 62 cells/cm² (about 400 cells/in²), or about 47 cells/cm² (about 300 cells/in²), and those having about 31 cells/cm² (about 200 cells/in²). A typical wall thickness is about 0.15 mm for about 62 cells/cm² (about 400 cells/in²). Wall thicknesses range from about 0.075 mm to about 1.5 mm.

The primer can be white or light-colored so that the code readily appears on it. The primer composition can comprise a light-colored pigment, such as a white pigment provided by TiO₂, to provide high contrast with relatively dark sections on the primer layer, e.g., formed by laser marking. The primer can contain a solvent, a binder, and a thickener. Examples of solvents include acetates and alcohols. Examples of binders include silicone, polysiloxane, polysilesquioxane, titanium containing resins, carbosilane resins, and polysilazane. The thickener can provide thixotropic/shear thinning behavior. Useful thickeners include fumed silica. The screen print primer formulation has a high viscosity to allow for an accurate patch placement with clean crisp lines during the application process. The thixotropic/shear-thinning properties of screen printing ink keep the primer on the surface, so after screen printing (e.g., after applying high shear rate) and a brief delay, the ink will return to a high viscosity. Advantageously, the short delay to recover the initial viscosity results in the ink film slightly flowing after application, remaining on the ceramic body, and forming an even and smooth surface on the body.

The primer is applied in liquid form to the ceramic body. A screen printing system can comprise three primary components—a screen, squeegee, and flood bar. The screen has a pattern in it that will allow or block the primer from being transferred through the screen. The squeegee then travels overs the pattern area to help transfer the primer to the target surface. The flood bar evenly covers the pattern with the fresh material to be ready for the next print stroke.

Screens useful in the practicing the disclosed embodiments are commercially available. Useful screen mesh sizes include but are not limited to 230/48, 305/34, 380/31, and 420/27. Preferred mesh sizes are 305/34, 380/31, and 420/27. The top value of a mesh size is the thread diameter per linear inch and the bottom value of a mesh size is the individual thread diameter in microns. The screen mesh size controls the amount of primer transferred to the surface of the ceramic body and the amount of primer penetrating the porous subsurface.

The current inventors have found that the squeegee angle contributes to the screen printing of the primer. The squeegee angle is the angle between the squeegee and the part being screen printed. A small squeegee angle leads to less primer flowing through the screen mesh onto the ceramic body. Highly corrugated ceramic bodies may require a different squeegee head or squeegee angle.

According to the embodiments disclosed herein, a layer of white primer is screen printed onto a portion of a fired ceramic body. In some embodiments, the thickness of the primer layer is less than 25 microns, less than 22 microns or even less than 20 microns. As discussed herein, the current inventors have found that a primer layer having a thickness of less than 25 microns can be used to result in substantially no flaking or cracking of the primer layer. The surface area of a honeycomb body that is coated by a primer layer can be a few square inches (e.g., 1-4 inches by 1-4 inches).

The data carrying mark applied to the primer layer comprises a machine-readable code or component such as a one-dimensional bar code (information conveyed via a series of different widths arranged in a one-dimensional line), two-dimensional matrix code (e.g., array of dark and light colored squares or boxes), etc. Machine-readable components can include a pattern of printed (e.g., relatively darkly colored) dots or other portions and unprinted (e.g., relatively lightly colored) portions. The use of different colors for the printed and unprinted portions can be used to increase the optical contrast between the printed and unprinted portions, thereby reducing the chance of a reading error. The machine readable code can comprise any type of information carrying pattern of marked and unmarked portions. The use of a two-dimensional matrix code provides a robust record of the information contained within the mark since a significant portion (e.g., as much as 30%) of the mark can be rendered unreadable without loss of information. In addition to machine-readable components, a mark can also include a human-readable component, e.g., an alpha-numeric data string, to facilitate extraction of the data when a computerized code reader is not available.

The data carrying mark can contain specific manufacturing information, such as the specific factory and/or kiln that produced the fired ceramic body, the batch, the production date and time, and/or a unique individual identification code (e.g., using a globally unique identifier system or other coding system in which no two codes are alike for some significant period of time). The unique individual identification code can contain the station, production line, and/or facility that provided the mark, the date, a sequential number of the fired ceramic body produced on that date, etc. It is also possible for the unique identifier to be further encrypted by a suitable encryption code to make it difficult for the coded information to be reverse engineered except by the manufacturer who of course holds the key to the encryption code.

Data for each unique individual identifier assigned and relating to an individual honeycomb can be stored in a relational database during the manufacturing sequence and can be extracted at a later time. As such, the origin, manufacturing materials and processes used, and equipment and apparatus used to manufacture the honeycomb body, as well as performance, properties, and attributes of the honeycomb body can be readily looked up after manufacture. Accordingly, any defect or variation in the honeycomb body can be readily related to the materials, processes, and/or equipment used. Thus, if desired, changes can be made in the raw materials, processes, etc. to effect changes in properties or attributes and to reduce the occurrence of such defects in future honeycomb articles.

The unique identifier information can be generated by a computer program that ensures that the code is unique to each individual honeycomb for a significant period of time, for example, greater than a decade. This allows for traceability of that particular honeycomb to any process that it underwent during its manufacture, including traceability to the raw materials used, the specific batches and processes employed, the date of manufacture, specific extruder lines and extrusion dies used, kilns and firing cycles, finishing operations employed, etc.

According to one embodiment disclosed herein, a method for applying a data carrying mark on a honeycomb body comprises a ceramic body loading step in which the ceramic body is engaged, held in proper orientation, and indexed to a material application station. In a screen printing step, a squeegee or other applicator is used to apply the primer through a screen or mesh onto the fired ceramic according to screen printing techniques. The ceramic body can then be indexed to a material drying station. In a drying step, the ceramic body can be located proximate to a vent or outlet and a drying gas (e.g., hot air) is flowed onto the ceramic body surface. The ceramic body can then be indexed to a coding station, such as a dot matrix coding station. The honeycomb body can be located proximate to a laser and the laser engages and applies the code to the primer layer by burning a pattern corresponding to the designated code into the primer layer.

According to methods disclosed herein, the data carrying mark or code is applied to a white primer layer using a laser to oxidize the primer solids and fuse them onto the surface of the ceramic body. In one embodiment, the laser is a carbon dioxide laser. The laser marking can be performed immediately following application of the primer layer without any intermediate drying or curing step. After the laser marking, the ceramic body can be heated to between 350-500° C. to calcine the primer layer. In some embodiments, the laser depth (depth that the laser energy penetrates into the primer layer) is greater than the thickness of the primer layer to facilitate adherence of the laser marking to the primer and of the primer to the skin of the ceramic body. It is to be appreciated that the laser depth can be set by changing the type and/or power of the laser, with respect to the composition and thickness of the primer. In some embodiments, the laser depth is less than the thickness of the primer layer, but adherence to the surface of the ceramic body is accomplished by crystallization of inorganic compounds in the primer, e.g., titania, caused by the laser energy which then adhere to the surface of the ceramic body. Preferably, the laser depth is about as deep as, or greater than, the thickness of the primer to facilitate the primer being fused to the ceramic body skin and the code being adhered to the primer.

Currently disclosed embodiments provide a screen printed primer layer wherein the layer has reduced cracking or flaking, provides improved laserability for the code to ease penetration of the primer layer while burning into the ceramic body surface and adhering the code to the ceramic body surface, increases laser marking speed (thus increasing throughput and reducing cost), reduces drying time (thus increasing throughput and reducing cost), and prevents primer adsorption into the cell matrix (penetration of the primer material through the outer skin and into the walls of the honeycomb body).

To more fully illustrate aspects of the currently disclosed embodiments, the following Examples are presented below.

### EXAMPLES

In the Examples, three different cordierite substrates (honeycomb bodies) commercially available from Corning Incorporated were used. Substrate 1 was made of cordierite and had a porosity of 40% (hereinafter “Substrate 1”). Substrate 2 was made of cordierite, has a more highly corrugated skin with peaks and valleys, and had a porosity of 65% (hereinafter “Substrate 2”). Substrate 3 was made of cordierite and had a porosity of 30% (hereinafter “Substrate 3”). As discussed herein, other porous ceramic bodies can be utilized.

A primer layer was screen printed onto Substrates 1, 2, and 3. The screen printing process was to screen print liquid primer onto the corresponding substrate using the indicated screen mesh (indicated in the corresponding Table, Figure, or description), as well as a squeegee and floor bar. The primer was dried by ambient air. Comparable Examples A-C include those examples that exhibited cracking or flaking, while Examples 1-4 did not.

In the Examples, the primer layer thickness, primer layer depth, and laser depth were measured by Scanning Electron Microscope (“SEM”) conditions as follows. A primer patch was cut into three cross sections consisting of the far right of the primer patch, the far left of the primer patch, and the center. The samples were then embedded into epoxy. Polished cross-section samples were prepared. A conductive carbon coating was evaporated onto the samples to reduce charging. The SEM instrument was Jeol JSM-6610LV at 15 kV and 500× magnification. In Tables 2-5 below, five measurements were taken from the same area on the samples taken.

The Examples used the primer composition listed in Table 1 below.

TABLE 1
Primer
PRIMER FORMULA (WEIGHT %)

| Primer Components | Role/Description | Weight % |
|---|---|---|
| Silicone Resin | Binder | 29% |
| | Solvent | 20.7 |
| Titania/TiO₂ | White Pigment | 49% |
| Fumed Silica | Thickener | 0.3% |
| | Dispersant Agent | 1% |
| | | 100% |

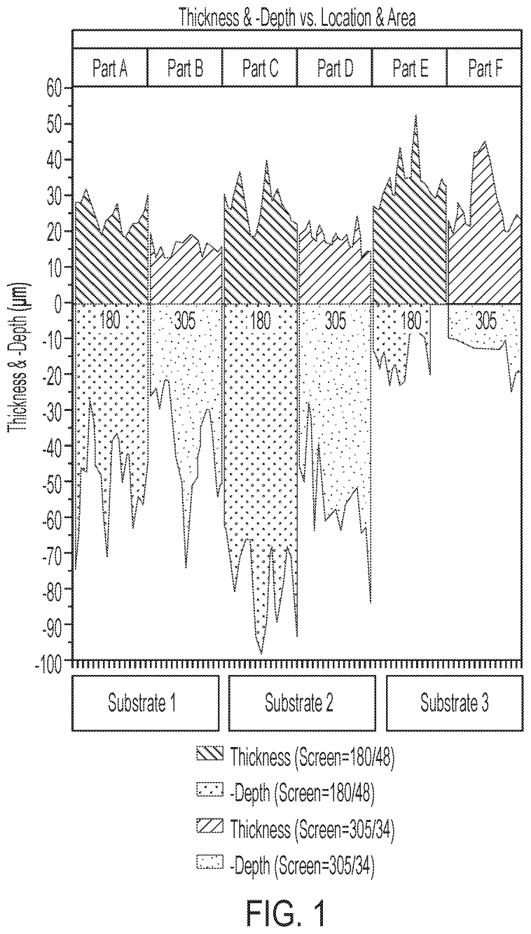

Comparative A and Example 1: This Example illustrates the impact of different screen mesh sizes on the amount of primer transferred to the substrate. Comparative A used 180/48 screen mesh and Example 1 used 305/34 screen mesh. As shown in FIG. 1, the thickness of the primer layer is reported in microns. As shown in FIG. 1, the thickness of the primer layer resulting from screen printing with the 180/48 mesh of Comparative A was greater than the thickness of the primer layer thickness resulting from screen printing with the 305/34 mesh of Example 1. Similarly, the depth of the screen printed layer into each substrate resulting from screen printing with the 180/48 mesh was greater than the depth of the screen printed layer into each substrate resulting from screen printing with the 305/34 mesh.

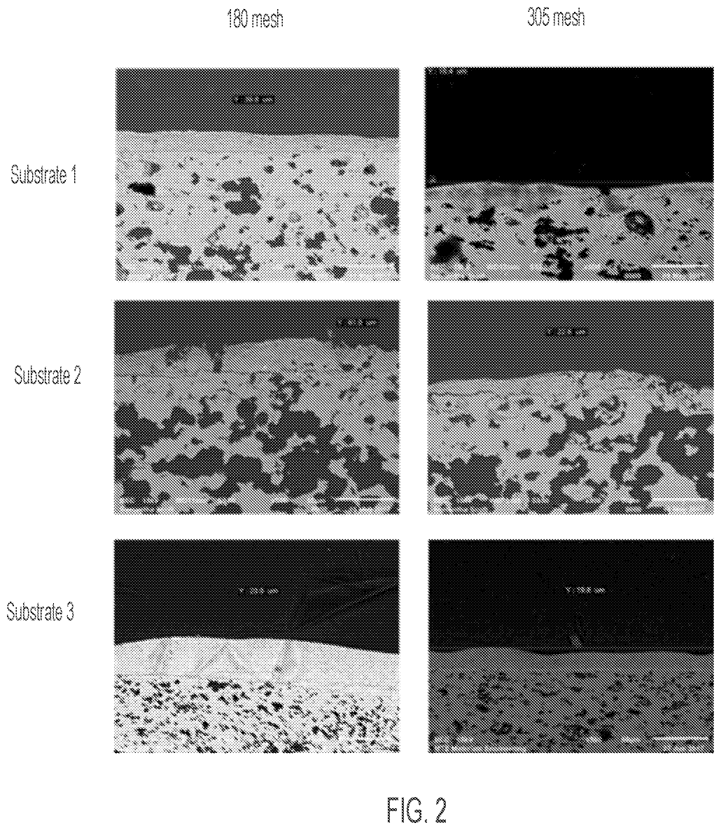

FIG. 2 shows SEMs corresponding to the results of FIG. 1. The porosity of the substrate also impacts the thickness of the resulting screen printed primer layer and the depth of the screen printed layer. The SEMs compare the difference in the thickness of the primer when applied to substrates with varying porosities with two different mesh size screens. Comparative A's 180/48 mesh deposits a thicker primer layer on the surface of the substrates regardless of porosity compared to the 305/34 mesh screen.

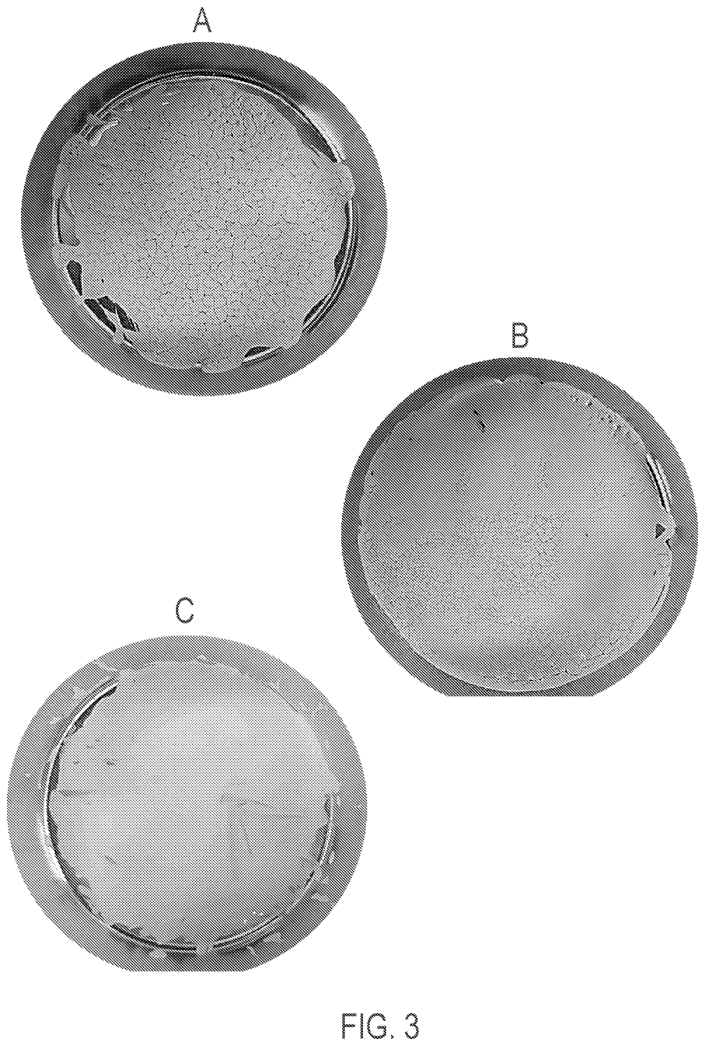

An aluminum cup test was conducted to demonstrate the relationship between primer thickness and primer cracking. An aluminum cup of the same dimensions was used for each of Samples A, B, and C as shown in FIG. 3. The amount of primer added was in different amounts to create different primer layer thickness: 2 grams for Sample A, 1 gram for Sample B, and 0.5 gram for Sample C. The primer was added to the aluminum cup and then dried at 160° C. for 15 hours. The thickest layer of Sample A shows primer cracking while the thinner layers of Samples B and C did not, as shown in FIG. 3. The aluminum cup test was used to confirm a relationship between primer thickness and primer cracking. When a primer layer flakes, cracking usually also occurs. In order to maintain the integrity of the primer patch, the primer layer should not crack or flake.

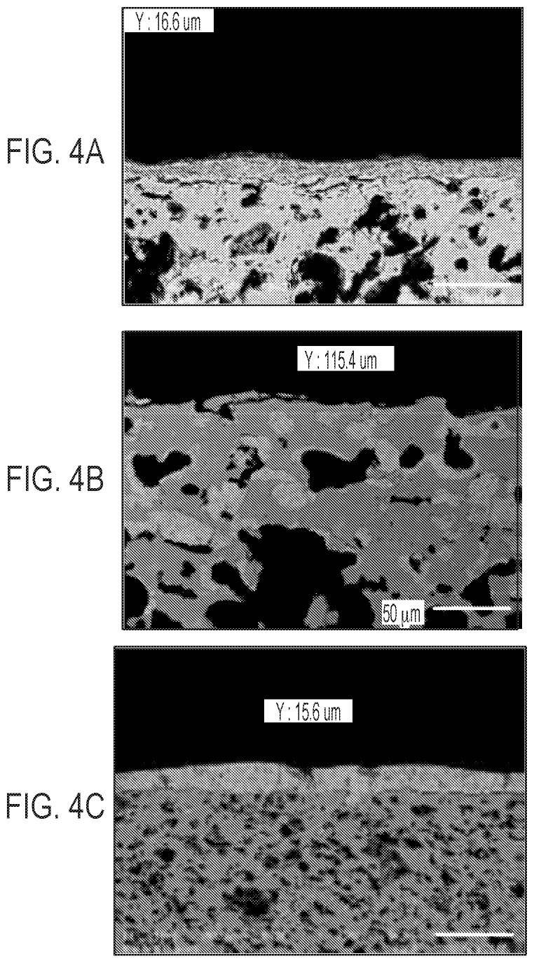

Example 2: This Example illustrates the impact of different porosity substrates on the thickness of the primer layer using the same screen mesh size. FIG. 4A shows an SEM of Substrate 1 (made of cordierite and having 40% porosity) with a screen printed primer layer using a 380/31 mesh screen size. FIG. 4B shows an SEM of Substrate 2 (made of cordierite and having 65% porosity) with a screen primer printed layer using a 380/31 mesh screen size. FIG. 4C shows an SEM of Substrate 3 (made of cordierite and having 30% porosity) with a screen printed primer layer using a 380/31 mesh screen size. The thickest primer layer is on the substrate with the lowest porosity substrate, while the thinnest primer layer is on the highest porosity substrate. This is directly related to the adsorption depth of the primer solvent into the skin of the ceramic body and the particle size of the primer solids (with larger particle sizes generally preventing deeper penetration of the primer into the skin).

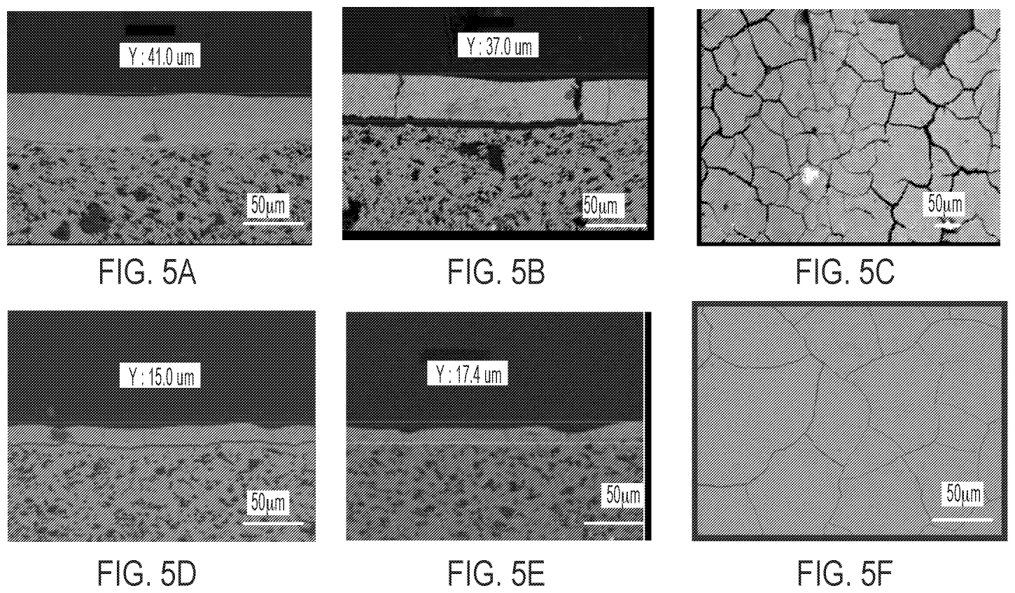

FIG. 5 shows a side by side SEM comparison after screen printing with 180/47 mesh screen and a 380/31 mesh screen on Substrate 3. FIG. 5A is pre-thermal shock printing with a 180/47 mesh on Substrate 3. FIG. 5B is a cross section of post-thermal shock primer with a 180/47 mesh on Substrate 3 of FIG. 5A. FIG. 5C is the post-thermal shock primer surface of FIG. 5B. FIG. 5D is pre-screen printing with a 380/31 mesh on Substrate 3. FIG. 5e is post-thermal shock primer with a 380/31 mesh on Substrate 3 of FIG. 5D. FIG. 5F is the post-thermal shock primer surface of FIG. 5E.

Example 3: Substrates 1, 2, and 3 were screen printed with 305/34 and 380/31 mesh screens. SEM was used to analyze the primer patch thickness, depth, and laser depth in five locations and the maximum thickness value was reported. The samples were polished cross-sections and the magnification was 500×.

The results for Substrate 1 are in Tables 2 and 3 below. Substrate 1 screen printed with a 305/34 mesh screen had a primer thickness of 22.2 microns or less for the five measured locations. Substrate 1 screen printed with a 305/34 mesh screen had a maximum depth of primer ranging from 23.8 to 34.6 microns for the five measured locations. Substrate 1 screen printed with a 305/34 mesh screen had a maximum laser depth of primer ranging from 14.6 to 20.2 microns for the five measured locations.

Substrate 1 screen printed with a 380/31 mesh screen had a primer thickness of 16.6 microns or less for the five measured locations. Substrate 1 screen printed with a 380/31 mesh screen had a maximum depth of primer ranging from 61.4 to 79 microns for the five measured locations. Substrate 1 screen printed with a 380/31 mesh screen had a maximum laser depth of primer ranging from 11.8 to 17.4 microns for the five measured locations.

The results for Substrate 2 are in Tables 4 and 5 below. Substrate 2 screen printed with a 305/34 mesh screen had a primer thickness of 7 microns or less for the five measured locations. Substrate 2 screen printed with a 305/34 mesh screen had a maximum depth of primer ranging from 85.4 to 149.4 microns for the five measured locations. Substrate 2 screen printed with a 305/34 mesh screen had a laser depth of primer ranging from 40.2 to 45.4 microns for the five measured locations. Substrate 2 screen printed with a 305/34 mesh screen had a laser depth that exceeded the corresponding thickness for each location. As discussed above, a laser depth at least as deep as the thickness of the primer layer facilitates the primer fusing to the substrate skin and the code or mark adhering to the primer layer.

Substrate 2 screen printed with a 380/31 mesh screen had a primer thickness of 12.2 microns or less. Substrate 2 screen printed with a 380/31 mesh screen had a maximum depth of primer ranging from 91.4 to 109.4 microns for the five measured locations. Substrate 2 screen printed with a 380/31 mesh screen had a laser depth of primer ranging from 43.4 to 57.8 microns for the five measured locations. Substrate 2 screen printed with a 380/31 mesh screen had a laser depth that exceeded the corresponding thickness for each location. As discussed above, a laser depth at least as deep as the thickness of the primer layer facilitates the primer fusing to the substrate skin and the code or mark adhering to the primer layer.

TABLE 2
Substrate 1: Screen Printed with 305/34 Mesh Screen
SEM Primer Patch Thickness Analysis - Maximum Thickness
(microns)

| | | | | | |
|---|---|---|---|---|---|
| | 1 | 2 | 3 | 4 | 5 |
| Max | 13.4 | 15.0 | 22.2 | 16.6 | 17.0 |

SEM Primer Patch Thickness Analysis - Maximum Depth
(microns)

| | | | | | |
|---|---|---|---|---|---|
| | 1 | 2 | 3 | 4 | 5 |
| Max | 27.8 | 33.0 | 24.2 | 23.8 | 34.6 |

SEM Primer Patch Thickness Analysis - Maximum Laser Depth
(microns)

| | | | | | |
|---|---|---|---|---|---|
| | 1 | 2 | 3 | 4 | 5 |
| Max | 14.6 | 15.8 | 16.6 | 20.2 | 15.8 |

TABLE 3
Substrate 1: Screen Printed with 380/31 Mesh Screen
SEM Primer Patch Thickness Analysis - Maximum Thickness
(microns)

| | | | | | |
|---|---|---|---|---|---|
| | 1 | 2 | 3 | 4 | 5 |
| Max | 11.8 | 14.2 | 12.6 | 16.6 | 15.4 |

SEM Primer Patch Thickness Analysis - Maximum Depth
(microns)

| | | | | | |
|---|---|---|---|---|---|
| | 1 | 2 | 3 | 4 | 5 |
| Max | 61.4 | 79.0 | 78.2 | 65.0 | 72.6 |

SEM Paint Patch Thickness Analysis - Maximum Laser Depth
(microns)

| | | | | | |
|---|---|---|---|---|---|
| | 1 | 2 | 3 | 4 | 5 |
| Max | 17.4 | 11.8 | 16.2 | 13.8 | 13.0 |

TABLE 4
Substrate 2: Screen Printed with 305/34 Mesh Screen
SEM Primer Patch Thickness Analysis - Maximum Thickness
(microns)

| | | | | | |
|---|---|---|---|---|---|
| | 1 | 2 | 3 | 4 | 5 |
| Max | 5.2 | 7.0 | 6.2 | 4.2 | 5.0 |

SEM Primer Patch Thickness Analysis - Maximum Depth
(microns)

| | | | | | |
|---|---|---|---|---|---|
| | 1 | 2 | 3 | 4 | 5 |
| Max | 85.4 | 96.2 | 95.8 | 149.4 | 127.0 |

SEM Primer Patch Thickness Analysis - Maximum Laser Depth
(microns)

| | | | | | |
|---|---|---|---|---|---|
| | 1 | 2 | 3 | 4 | 5 |
| Max | 43.8 | 41.4 | 42.6 | 40.2 | 45.4 |

TABLE 5
Substrate 2: Screen Printed with 380/31 Mesh Screen
SEM Paint Patch Thickness Analysis - Maximum Thickness
(microns)

| | | | | | |
|---|---|---|---|---|---|
| | 1 | 2 | 3 | 4 | 5 |
| Max | 9.4 | 12.2 | 8.6 | 8.6 | 12.6 |

SEM Paint Patch Thickness Analysis - Maximum Depth
(microns)

| | | | | | |
|---|---|---|---|---|---|
| | 1 | 2 | 3 | 4 | 5 |
| Max | 91.4 | 96.6 | 109.4 | 107.4 | 101.0 |

SEM Paint Patch Thickness Analysis - Maximum Laser Depth
(microns)

| | | | | | |
|---|---|---|---|---|---|
| | 1 | 2 | 3 | 4 | 5 |
| Max | 49.4 | 48.6 | 43.4 | 57.8 | 45.0 |

Comparative B and Example 4: As shown in Table 6, Comparative B's Substrate 3 screen printed with a 180/37 screen mesh had a maximum thickness ranging from 25.4 to 37 microns, and exhibited flaking. In comparison, as shown in Table 7, Example 4 includes Substrate 3 screen printed with a 380/31 screen mesh, which had a thickness ranging from 14.6 to 22.5 microns and did not exhibit flaking or cracking.

TABLE 6
Substrate 3: Screen Printed with 180/37 Mesh Screen

| 180/37 Primer Thickness | | | | | 180/37 Primer Adsorption | | | | |
|---|---|---|---|---|---|---|---|---|---|
| SEM Paint Patch Thickness Analysis- | | | | | SEM Paint Patch Depth Analysis- | | | | |
| Maximum Thickness (microns) | | | | | Maximum Depth (microns) | | | | |
| | | | Center | Center | | | | Center | Center |
| | Left | Right | Peak | Valley | | Left | Right | Peak | Valley |
| Area 1 | 28.6 | 23.4 | | 34.6 | Area 1 | 15.8 | 19.4 | | 15 |
| Area 2 | 30.6 | 25.4 | 21.8 | | Area 2 | 16.2 | 14.2 | 9.8 | |
| Area 3 | 26.2 | 23 | 24.2 | | Area 3 | 24.6 | 8.6 | | 12.2 |
| Area 4 | 29.8 | 24.2 | 33.4 | | Area 4 | 8.6 | 11 | 11.8 | |
| Area 5 | 29.4 | 25 | | 37 | Area 5 | 17.4 | 18.6 | 17.4 | |
| Max | 30.6 | 25.4 | 33.4 | 37 | Max | 24.6 | 19.4 | 17.4 | |

TABLE 7
Substrate 3: Screen Printed with 380/31 Mesh Screen

| 380/31 Primer Thickness | | | | | 3801/31 Primer Adsorption | | | | |
|---|---|---|---|---|---|---|---|---|---|
| SEM Paint Patch Thickness Analysis- | | | | | SEM Paint Patch Depth Analysis- | | | | |
| Maximum Thickness (microns) | | | | | Maximum Depth (microns) | | | | |
| | | | Center | Center | | | | Center | Center |
| | Left | Right | Peak | Valley | | Left | Right | Peak | Valley |
| Area 1 | 15.8 | 22.6 | 12.2 | 15.4 | Area 1 | 13 | 11 | 11.4 | 9.4 |
| Area 2 | 15.8 | 16.2 | 13 | 18.6 | Area 2 | 9 | 11 | 8.6 | 12.2 |
| Area 3 | 14.6 | 18.6 | 13.4 | 18.6 | Area 3 | 8.6 | 9 | 13 | 7.8 |
| Area 4 | 12.6 | 22.2 | 13.8 | 19.8 | Area 4 | 13 | 18.2 | 13 | 11.8 |
| Area 5 | 15.4 | 17.4 | 14.6 | 19.4 | Area 5 | 8.6 | 13 | | |
| Max | 15.8 | 22.6 | 14.6 | 19.8 | Max | 13 | 18.2 | 13 | 12.2 |

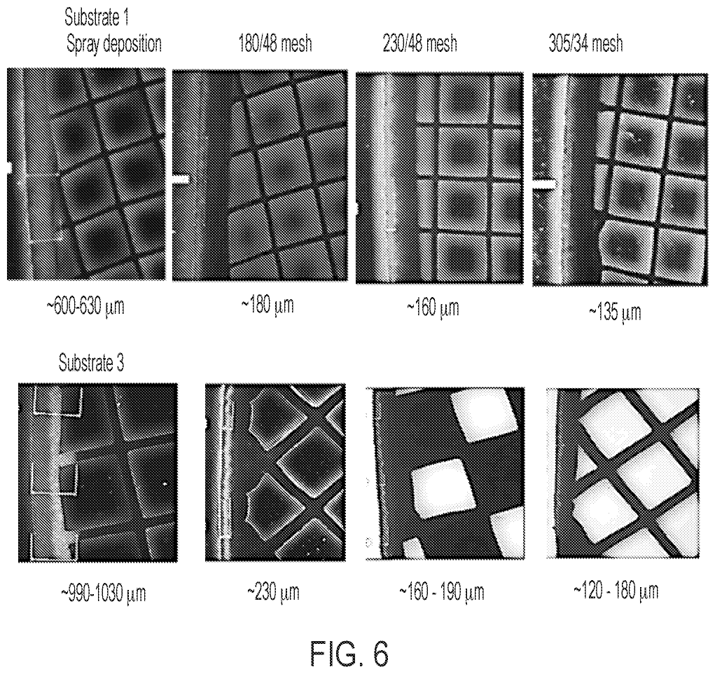

FIG. 6 shows the binder penetration into the substrate skin. These pictures were taken by Fluorescence Optical Microscopy (Olympus IX70) and excited at 350 nm with a UV light showing the binder penetration. The light gray area is an optical binder to show the binder penetration.

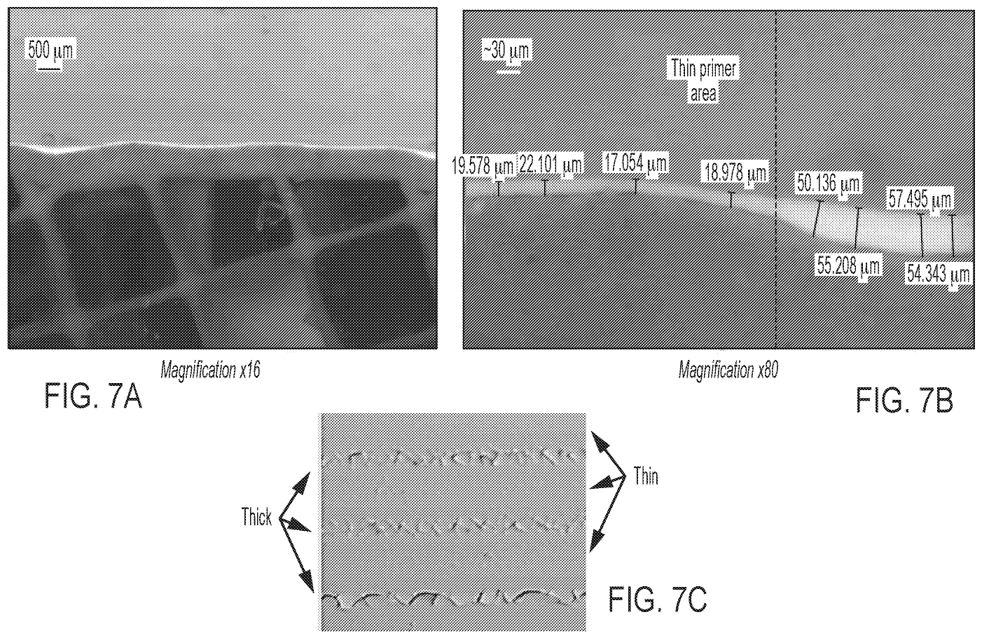

Example 5 and Comparative C: A primer patch was screen printed using a 305/34 mesh screen onto Substrate 3 for this Example. FIG. 7A using a magnification of 16× shows the screen printed primer on Substrate 3 before calcination. FIG. 7B using a magnification of 80× shows the Substrate 3 having screen printed primer of FIG. 7A. The region labeled “Thin primer area” in FIG. 7B illustrates Example 5 inventive primer thicknesses of 17.054 microns, 18.978 microns, 19.578 microns, and 22.101 microns. The region labeled “Thick primer area” in FIG. 7B is Comparative C and illustrates primer Thicknesses of 50.136 microns, 54.343 microns, 55.208 microns, and 57.495 microns. FIG. 7C shows the primer of FIG. 7B after calcination. The Example 5 inventive primer layers having a thickness of between 17.054 and 22.101 microns did not crack while the Comparative C primer layers having a thickness of between 50.136 and 57.405 microns cracked. Example 5 inventive primer layers having a thickness of less than or equal to 25 microns did not crack. Thus, Example 5 demonstrates the impact of primer thickness on cracking.

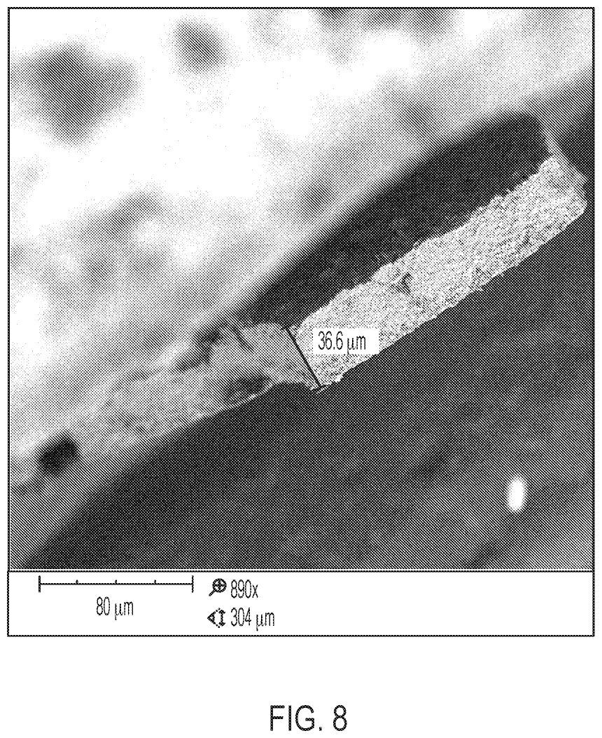

Comparative D: A primer patch was screen printed onto Substrate 1. FIG. 8 shows an SEM of the screen printed primer on Substrate 1. The primer Thickness was 36.6 microns and the SEM shows that the primer layer flaked. Thus, Comparative D demonstrates the impact of primer thickness on flaking.

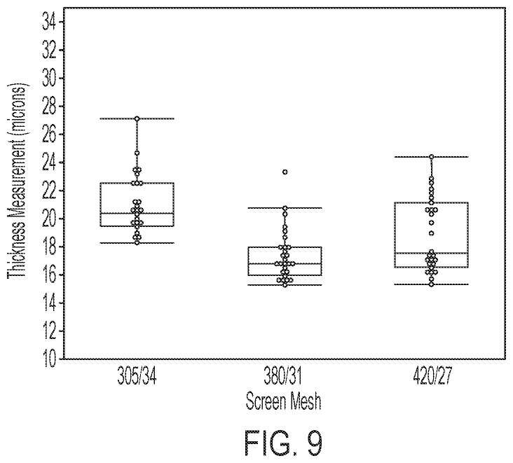

Example 6: Primer patches were screen printed using 305/34, 380/31, and 420/27 mesh screens on Substrate 3 to determine the effect of screen mesh on patch thickness. A squeegee and flood bar were used for screen printing. FIG. 9 shows a box and whisker plot for the primer thickness on Substrate 3 using 305/34, 380/31, and 420/27 mesh for Example 6. The difference in the average thickness when using the 305/34 mesh screen is higher than using the 380/31 and 420/27 mesh screens. The difference in primer thickness for patches made using the 380/31 and 420/27 mesh screens is not significant.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, ranges, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

1. A fired ceramic article comprising:
a screen printed layer of primer on a portion of the fired ceramic body, wherein the thickness of the primer layer is less than 25 microns; and
a machine-readable code laser marked onto the screen printed layer of primer.

2. The fired ceramic article of claim 1 wherein the fired ceramic article is porous and the primer layer penetrates the porous ceramic body to a depth of at least 10 microns.

3. The fired ceramic article of claim 1, wherein before being dried, the primer layer comprises TiO₂ pigment, binder, high boiling solvent, and thickener.

4. The fired ceramic article of claim 1, wherein after being dried, the primer layer comprises TiO₂ pigment.

5. The fired ceramic article of claim 1, wherein the machine-readable code contains traceability information.

6. The fired ceramic article of claim 1, wherein the thickness of the primer layer is substantially uniform.

7. The fired ceramic article of claim 1, wherein the laser depth exceeds the thickness of the primer.

8. The fired ceramic article of claim 1, wherein the thickness of the primer layer is greater than zero to less than or equal to about 22 microns.

9. The fired ceramic article of claim 1, wherein the primer layer is substantially free of flaking.

10. The fired ceramic article of claim 1, wherein the primer layer is substantially free of cracking.

11. A wall-flow filter comprising the fired ceramic article of claim 1.

12. A label comprising:
(a) a layer of primer wherein the primer layer was screen printed and the thickness of the primer layer is greater than zero to less than or equal to 25 microns; and
(b) a machine-readable code laser marked onto the primer layer.

13. A method of marking a ceramic article comprising the steps of:
(a) screen printing a layer of primer at a thickness of greater than zero to less than 25 microns onto a portion of a fired ceramic article;
(b) drying the primer layer; and
(c) laser marking a machine-readable code on the dried primer layer.

14. The method of claim 13 wherein the fired ceramic article is porous and the primer layer penetrates the porous fired ceramic article for at least 10 microns.

15. The method of claim 13, wherein in the step (a), the primer layer comprises TiO₂ pigment, binder, high boiling solvent, and thickener.

16. The method of claim 13, wherein in the step (a) the thickness of the primer layer is greater than zero to less than or equal to about 22 microns.

17. The method of claim 13, wherein the thickness of the primer layer is substantially uniform.

18. The method of claim 13, wherein the primer layer is substantially free of cracking.

19. The method of claim 13, wherein the machine-readable code contains traceability information.

20. The method of claim 13, wherein in the step (c), the machine-readable code is marked to the porous fired ceramic article.
